(19) United States
(12) Patent Application Publication
(10) Pub. No.: US 2011/0054362 A1
(43) Pub. Date: Mar. 3, 2011

(54) MASSAGE APPARATUS AND MASSAGE METHOD THEREOF

(75) Inventors: ZENG-XI XIAO, Shenzhen City (CN); TE-HUA LEE, Tu-Cheng (TW)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/824,433

(22) Filed: Jun. 28, 2010

(30) Foreign Application Priority Data
Aug. 28, 2009 (CN) 200910306309.2

(51) Int. Cl. A61H 1/00

(52) U.S. Cl. 601/1

(57) ABSTRACT

A massage apparatus and a massage method are provided. The method includes the following steps: measuring a parameter value of the one kind of physiological parameter of a part of a human body; comparing the measured parameter value with the reference ranges; obtaining a massage command corresponding to one of the reference ranges when the measured parameter value falls within the one of the reference ranges; massaging the part of the human body within a predetermined time interval according to the obtained massage command

### BACKGROUND

1. Technical Field

The present disclose relates to massage and, particularly, to a massage apparatus and a massage method thereof.

2. Description of Related Art

Conventional massage apparatuses cannot automatically adjust massage modes according to the needs of the user, and one kind of physiological cannot automatically stop massaging a healthy area. Therefore, it cannot apply a proper therapeutic massage.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of a massage apparatus and a massage method thereof. Moreover, in the drawings, like reference numerals designate corresponding parts throughout the several views.

FIG. 1 is a block diagram showing a massage apparatus, in accordance with an exemplary embodiment.

FIG. 2 is a flowchart of a massage method applied in the massage apparatus of FIG. 1, in accordance with an exemplary embodiment.

### DETAILED DESCRIPTION

The embodiments of the disclosure will now be described in detail, with reference to the accompanying drawings.

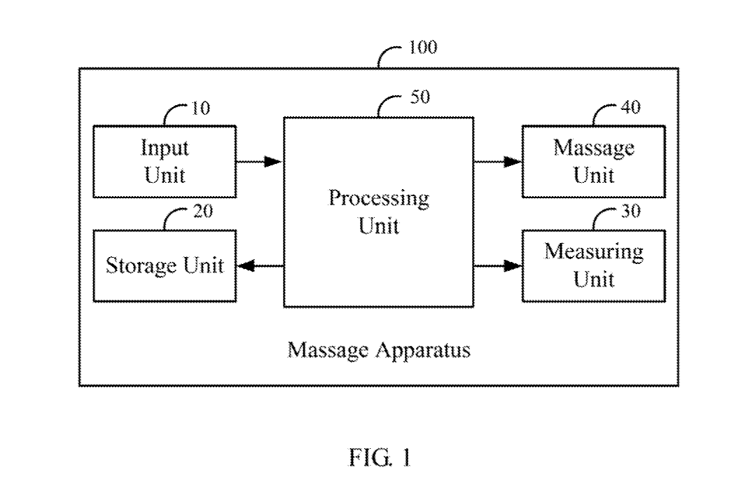

Referring to FIG. 1, a massage apparatus 100 includes an input unit 10, a storage unit 20, a measuring unit 30, a massage unit 40, and a processing unit 50.

The input unit 10 is configured to generate an activation signal for informing the measuring unit 30 to start working in response to user input.

The storage unit 20 stores a plurality of reference ranges of one kind of physiological parameters and a plurality of massage commands. Each of the reference ranges corresponds to one of the massage commands Each massage command represents a massage mode. In the embodiment, the physiological parameter is a skin impedance of a human body. Different parts of the human body have different skin impedance values. When the skin impedance value of one part falls in one reference range, the massage apparatus 100 determines that one part is not healthy, thus an appropriate massage is applied on the part where needed.

The measuring unit 30 is configured to measure the skin impedance of the human body upon receiving the activation signal. In the embodiment, the measuring unit 30 includes two electrodes, and a plurality of electronic elements including resistors, capacitors, amplifiers, and an Analog-to-Digital Conventer (ADC). When beginning to measure the skin impedance of the part of the human body, the two electrodes contacting the part of the human body generate electrical signals. The electrical signals are then processed by the electronic elements to obtain the skin impedance.

The massage unit 40 is configured to massage different parts of the human body according to the massage commands

The processing unit 50 is configured to obtain the skin impedance from the measuring unit 30 and informs the measuring unit 30 to stop working after obtaining the skin impedance. The processing unit 50 is further configured to compare the obtained skin impedance with the reference ranges. If the obtained skin impedance is within one reference range, the processing unit 50 obtains the massage command corresponding to the one reference range and controls the massage unit 40 to massage the part of the human body within a predetermined time interval according to the one massage command. It should be noted that in the embodiment when the predetermined time interval elapses, the processing unit 50 controls the measuring unit 30 to resume working. By doing so, the massage apparatus 100 can automatically massage the part of the human body according to different preset massage modes until the part is healthy.

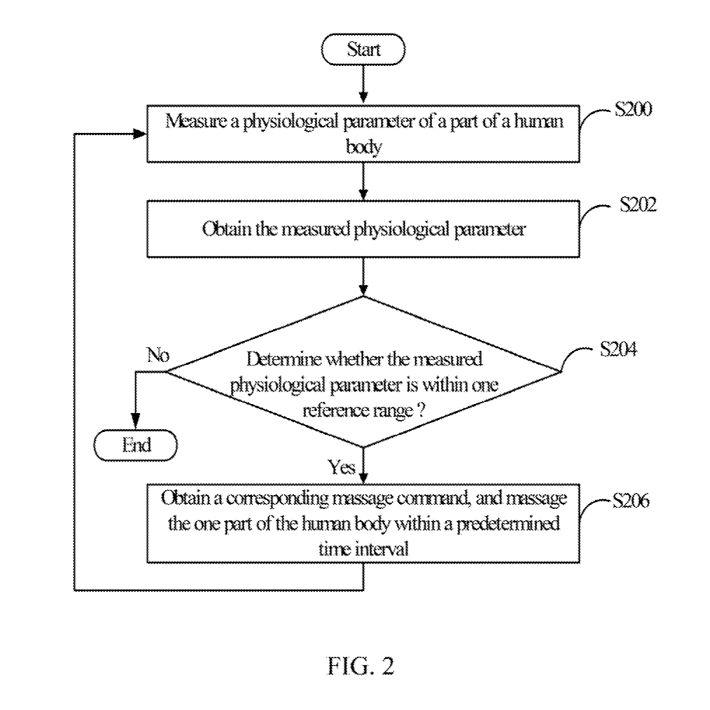

Referring to FIG. 2, a flowchart of a method for massaging one part of a human body is illustrated.

In step S200, the measuring unit 30 measures the physiological parameter of one part of the human body upon receiving the activation signal.

In step S202, the processing unit 50 obtains the measured physiological parameter from the measuring unit 30 and controls the measuring unit 30 to stop measuring the physiological parameter.

In step S204, the processing unit 50 compares the measured physiological parameter with the reference ranges. If the measured physiological parameter is within one reference range, the procedure goes to step S206. Otherwise, the procedure ends.

In step S206, the processing unit 50 obtains the massage command corresponding to the one reference range and controls the massage unit 40 to massage the one part of the human body within the predetermined time interval according to the obtained massage command. When the predetermined time interval elapses, the processing unit 50 controls the measuring unit 30 to resume to working, thus the procedure returns to step S200.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A massage apparatus, comprising:
a storage unit configured to store a plurality of reference ranges of one kind of physiological parameters and a plurality of massage commands, wherein each of the reference ranges corresponds to one of the massage commands;
a measuring unit configured to measure parameter values of the one kind of physiological parameter of different parts of a human body;
a massage unit configured to massage different parts of the human body according to the massage commands; and
a processing unit configured to obtain a measured parameter value of one part of the human body from the measuring unit, compare the measured parameter value with the reference ranges, and obtain a massage command corresponding to one of the reference ranges when the measured parameter value falls within the one of the reference ranges, and further configured to control the massage unit to massage the one part of the human body within a predetermined time interval according to the obtained massage command

2. The massage apparatus of claim 1, further comprising an input unit configured to generate an activation signal for informing the measuring unit to measure the parameter values of the one kind of physiological parameter of different parts of a human body.

3. The massage apparatus of claim 1, wherein the processing unit controls the measuring unit to stop working when the processing unit obtains the measured parameter value from the measuring unit, the processing unit controls the measuring unit to begin to work when the predetermined time interval elapses.

4. The massage apparatus of claim 1, wherein the one kind of physiological parameter is skin impedance.

5. A massage method applied in a massage apparatus, the massage apparatus storing a plurality of reference ranges of one kind of physiological parameter and a plurality of massage commands, each of the reference ranges corresponding to one of the massage commands, the method comprising:
measuring a parameter value of the one kind of physiological parameter of a part of a human body;
comparing the measured parameter value with the reference ranges;
obtaining a massage command corresponding to one of the reference ranges when the measured parameter value falls within the one of the reference ranges;
massaging the part of the human body within a predetermined time interval according to the obtained massage command

6. The method of claim 5, further comprising:
stopping measuring parameter values of the one kind of physiological parameter after obtaining the measured parameter value; and
resuming to measure parameter values of the one kind of physiological parameter when the predetermined time interval elapses.

7. The method of claim 5, wherein the one kind of physiological parameter is skin impedance.
